(19) United States
(12) Patent Application Publication
(10) Pub. No.: US 2025/0214860 A1
(43) Pub. Date: Jul. 3, 2025

(54) METHOD FOR PRODUCING PROTON-CONTAINING OXIDE, DENSE BODY OF PROTONCONTAINING BASIC COMPOSITE OXIDE, SOLID ELECTROLYTE, FUEL CELL, HYDROGEN PRODUCTION CELL, HYDROGEN SENSOR, OR AMMONIA SYNTHESIS CELL, AND METHOD FOR PRODUCING SAME

(71) Applicant: TOHOKU UNIVERSITY, Sendai-shi, Miyagi (JP)

(72) Inventors: Akihiro ISHII, Sendai-shi (JP); Hitoshi TAKAMURA, Sendai-shi (JP); Daisuke KUME, Sendai-shi (JP)

(73) Assignee: TOHOKU UNIVERSITY, Sendai-shi, Miyagi (JP)

(21) Appl. No.: 18/851,802

(22) PCT Filed: Nov. 21, 2022
(86) PCT No.: PCT/JP2022/043010

§ 371 Date: Nov. 13, 2024

(30) Foreign Application Priority Data
Mar. 31, 2022 (WO) PCT/2022/016486

(51) Int. Cl. C01G 25/02; C01G 25/00

(52) U.S. Cl. CPC C01G 25/02; C01G 25/006; C01P 2002/30; C01P 2006/37

(57) ABSTRACT

A method for producing a proton-containing oxide that includes reacting a basic oxide with a carboxylic acid melt having a pKa of 4 or more to introduce protons into the basic oxide to obtain a proton-containing oxide, a dense body of the proton-containing basic composite oxide, and a fuel cell, a hydrogen production cell, a hydrogen sensor, or an ammonia synthesis cell, and the method for producing the same.

### TECHNICAL FIELD

The present invention relates to a method for producing a proton-containing oxide, and a method for producing a fuel cell, a hydrogen production cell, a hydrogen sensor, or an ammonia synthesis cell using the proton-containing oxide obtained by the method for producing a proton-containing oxide.

The present invention also relates to a dense body of a proton-containing basic composite oxide, and a solid electrolyte, a fuel cell, a hydrogen production cell, a hydrogen sensor, or an ammonia synthesis cell including the dense body.

### BACKGROUND ART

Oxides that are thermally and chemically stable in an intermediate temperature range of about 300 to 600° C., and exhibit high proton conductivity are required in various electrochemical devices such as fuel cells, hydrogen production cells, hydrogen sensors, and ammonia synthesis cells.

However, since most of the known proton-conductive oxides are synthesized through a sintering treatment at a high temperature (about 1000° C.), they are limited to a perovskite type crystal system or a related crystal system, or a specific material system such as the phosphate glass described in Patent Document 1, and there are restrictions in terms of the degree of freedom of the form including the crystal structure and the degree of freedom of the composition.

It is thought that proton-conductive oxides, which decompose at high temperatures but are stable up to an intermediate temperature range of 300 to 600° C., are rich in a variety of material systems and crystal systems, and research and development on a method for producing the proton-conductive oxides is advancing.

For example, Patent Document 2 and Non-Patent Documents 1 and 2 describe that alkali ions in a specific alkali-containing sample are electrochemically substituted with protons by ion exchange using hydrogen gas and a DC voltage to obtain a dense body of a proton-conductive oxide stable in the intermediate temperature range. However, Patent Document 2 only describes that a phosphate glass containing alkali oxides and oxides of polyvalent positive elements having a plurality of oxidation states is used as a sample, Non-Patent Document 1 only describes that each of the crystals of NaNbWO₆, Na₃Zr₂Si₃PO₁₂, NaMgPO₄, NaLa(PO₄)₃, Li₃Sc₂(PO₄)₃ and Li₅La₃Nb₂O₁₂ is used as a sample, and Non-Patent Document 2 only describes that Na₃Zr₂Si₃PO₁₂ is used as a sample. As described in Non-Patent Document 1, when NaNbWO₆ is used as a sample, not only the substitution of sodium ions with protons but also the reaction of W⁶⁺+e⁻→W⁵⁺ proceeds at the same time, and the ion exchange proceeds only in the immediate vicinity of the anode. Thus, application for easily-reduced oxides such as NaNbWO₆ is not possible. Further, in the above-mentioned electrochemical ion exchange method, it is necessary to apply a proton introduction electrode and an alkali ion absorbing electrode to an alkali-containing sample, and thus the method cannot be applied to a porous material or a powdery sample.

In addition, Patent Document 3 and Non-Patent Documents 3 and 4 describe a method of substitution with protons using a chemical potential difference.

For example, Patent Document 3 describes that a powder of a composite oxide represented by Li_{7-x-y}HₓLa₃Zr_{2-y}M_{y}O₁₂ (M is Ta and/or Nb, 3.2<x≤7−y, 0.25<y<2) and having a single phase of a garnet-type structure belonging to a cubic system is obtained as a proton-conductive composite oxide, from a powder of a substituted garnet-type lithium-ion-conductive oxide that has excellent lithium-ion conductivity and is free from aluminum by exchanging lithium ions with protons at 80° C. or higher in a solution of a substance having a hydroxy group or a carboxy group.

Non-Patent Document 3 describes that by immersing Li_{13.9}Sr_{0.1}Zn(GeO₄)₄ powder in an aqueous solution of acetic acid to exchange lithium ions with protons, and then applying a pressure of 2000 MPa to the resulting powder of the proton-substituted product and also applying a DC voltage in hydrogen, a dense body is obtained.

Non-Patent Document 4 describes that a Li₇La₃Nb₂O₁₂ dense body is immersed in water at room temperature for 14 days to obtain a completely ion-exchanged dense body having a 3 mm thickness.

However, ion exchange in the method described in Patent Document 3 can be performed only for a powder sample, and cannot be applied to a sample of a dense body. In addition, the method described in Non-Patent Document 3 cannot be applied to an oxide sample that is easily reduced, and to begin with, a process for producing a dense body into which protons have been introduced is impractical. Further, it is also necessary to apply a proton introduction electrode and a Li absorbing electrode to the sample obtained by applying pressure, and the process is complicated. The method described in Non-Patent Document 4 is also considered to be impractical because applicable material systems are limited and a long time is required.

### CITATION LIST

### Patent Literature

Patent Document 1: JP 3905899 B

Patent Document 2: JP 6041606 B

Patent Document 3: WO 2017/033865

### Non-Patent Literature

Non-Patent Document 1: Tyuuonn nennryoudenchi you kotai dennkaishitu no kaihatu: Kouonn alkali-proton tikanhou niyoru shinnbusshitu kaitaku, Kagaku kenkyuuhi jyosei jigyou Kenkyuuseika houkokusyo, Japan, May 25, 2017, No. 15K14126

Non-Patent Document 2: S. Tsukuda et al., Inorg. Chem. 2017, Vol. 56, No. 22, pp. 13949 to 13954

Non-Patent Document 3: T. Wei et al., Chem. Mater. 2017, Vol. 29, No. 4, pp. 1490 to 1495

Non-Patent Document 4: L. Truong et al., J. Mater. Chem. A, 2013, Vol. 1, No. 43, pp. 13469 to 13475

### SUMMARY OF INVENTION

### Technical Problem

As described above, studies have been made on the synthesis of proton-conductive oxides that are stable up to an intermediate temperature range of 300 to 600° C. However, Patent Documents 1 to 3 and Non-Patent Documents 1 to 4 merely describe methods for producing oxides into which protons have been introduced (hereinafter referred to as “proton-containing oxides”) in which the form (powder, porous body, dense body, or the like) and/or composition (crystal structure or the like) of a sample to which protons are introduced are limited. There is a demand to develop an efficient production method which has little restriction on the form and composition of sample and by which a proton-containing oxide can be more easily obtained.

Therefore, an object of the present invention is to provide a production method that can be applied to a raw material in any form of a powder, a porous body, and a dense body, and by which a proton-containing oxide can be easily obtained. Another object of the present invention is to provide a novel dense body of a proton-containing basic composite oxide that can be obtained by the production method of the present invention.

Also, another object of the present invention is to apply a solid electrolyte, a fuel cell, a hydrogen production cell, a hydrogen sensor, or an ammonia synthesis cell including a dense body of the proton-containing oxide or the proton-containing basic composite oxide obtained by the production method of the present invention, and methods for producing the same.

### Solution to Problem

The above issues of the present invention have been solved by the following means.
[1]

A method for producing a proton-containing oxide including, reacting a basic oxide with a carboxylic acid melt having a pKa of 4 or more to introduce protons into the basic oxide to obtain a proton-containing oxide.
[2]

The method for producing the proton-containing oxide according to [1] in which the basic oxide is a basic composite oxide containing at least one element species selected from B, Mg, Al, Li, Ca, S, La, Sr, P, Ba, Na, and K, and at least one element species selected from Si, Ti, Zr, Hf, Lu, Y, and Sc.
[3]

The method for producing the proton-containing oxide according to [1] or [2] in which the basic oxide is of a garnet type or a caswellsilverite analogous type.
[4]

The method for producing the proton-introduced oxide according to any one of [1] to [3] in which the carboxylic acid melt is a fatty acid melt.
[5]

The method for producing the proton-containing oxide according to any one of [1] to [4] in which a reaction temperature of the reaction is in a range from 150 to 350° C.
[6]

The method for producing the proton-containing oxide according to any one of [1] to [5] in which a reaction time of the reaction is in a range from 1 to 20 hours.
[7]

The method for producing the proton-containing oxide according to any one of [1] to [6], further including washing after the reaction.
[8]

The method for producing the proton-containing oxide according to any one of [1] to [7] in which the washing is performed using an oil or fat.
[9]

A method for producing a fuel cell, a hydrogen production cell, a hydrogen sensor, or an ammonia synthesis cell, the method including, incorporating, as a solid electrolyte, the proton-containing oxide obtained by the method for producing the proton-containing oxide according to any one of [1] to [8].
[10]

A dense body of a proton-containing basic composite oxide, including at least one element species selected from B, Mg, Al, Li, Ca, S, La, Sr, P, Ba, Na and K, and at least one element species selected from Si, Ti, Zr, Hf, Lu, Y and Sc, and further containing an oxide ion.
[11]

A solid electrolyte including the dense body of the proton-containing basic composite oxide according to [10].
[12]

A fuel cell, a hydrogen production cell, a hydrogen sensor, or an ammonia synthesis cell including the solid electrolyte according to [11].

### Advantageous Effects of Invention

The production method of the present invention can be applied to a raw material in any form of a powder, a porous body, and a dense body, and makes it possible to easily obtain a proton-containing oxide.

In addition, the dense body of the proton-containing basic composite oxide of the present invention is a novel proton-containing basic composite oxide that can be obtained by the production method of the present invention, has a high degree of freedom of design with respect to form, composition, and electron conductivity, and can be used in a solid electrolyte of a fuel cell, a hydrogen production cell, a hydrogen sensor, or an ammonia synthesis cell.

### BRIEF DESCRIPTION OF DRAWINGS

FIG. 1 shows a graph in which a free energy change ΔG°_{Oxide→Hydroxide} of the generation of a hydroxide from a simple oxide is plotted against temperature.

FIG. 2 shows a graph in which a change in free energy of formation ΔG°_{Oxide} of a simple oxide is plotted against temperature.

FIG. 3 is a schematic explanatory view of an embodiment of an apparatus for ion exchange reaction between a basic oxide and a carboxylic acid melt in the production method according to the present invention.

FIG. 4 shows EDS (energy dispersive X-ray spectroscopy) spectra of Na₂ZrO₃ before and after the ion exchange reaction. The lower spectrum is a spectrum of Na₂ZrO₃ before introduction of protons, and the upper spectrum is a spectrum of Na₂ZrO₃ after introduction of protons.

FIG. 5 shows X-ray diffraction spectra of Na₂ZrO₃ before and after the ion exchange reaction. The lower spectrum is a spectrum of Na₂ZrO₃ before introduction of protons, and the upper spectrum is a spectrum of Na₂ZrO₃ after introduction of protons.

FIG. 6 illustrates estimated change in the crystal structure of Na₂ZrO₃ by the ion exchange reaction. FIG. 6(a) illustrates the crystal structure of Na₂ZrO₃ before introduction of protons, and FIG. 6(b) illustrates the crystal structure of Na₂ZrO₃ after introduction of protons.

FIG. 7 shows X-ray diffraction spectra of Al-doped LLZ before and after an ion exchange reaction. The lower spectrum is a spectrum of the Al-doped LLZ before introduction of protons, and the upper spectrum is a spectrum of the Al-doped LLZ after introduction of protons.

FIG. 8 shows Raman spectra of Al-doped LLZ before and after an ion exchange reaction. The lower spectrum is a spectrum of the Al-doped LLZ before introduction of protons, and the upper spectrum is a spectrum of the Al-doped LLZ after introduction of protons.

FIG. 9 shows the results of analysis in the depth direction by Raman spectroscopy of pellet-shaped sintered bodies of Al-doped LLZ and Ta-doped LLZ after an ion exchange reaction. ▾ indicates a plot of Ta-doped LLZ and ▴ indicates a plot of Al-doped LLZ.

FIG. 10 shows an SEM (scanning electron microscope) image of a fracture near the surface of a pellet-shaped sintered body of Al-doped LLZ after ion exchange.

FIG. 11 is a plot showing ion exchange reaction characteristics of acidic compounds. The relationship between the ion exchange reaction temperature indicated on the horizontal axis and the pKa of the acidic compound indicated on the vertical axis was plotted. For the test in which protons penetrated to a depth of 10 μm or more, the maximum depth at which introduction of protons was confirmed is also shown.

FIG. 12 shows the result of analysis in the depth direction by Raman spectroscopy of a pellet-shaped sintered body of Al-doped LLZ after the ion exchange reaction. ♦ represents a plot when behenic acid is used at a reaction temperature of 190° C., ▴ represents a plot when adipic acid is used at a reaction temperature of 180° C., and ● represents a plot when behenic acid is used at a reaction temperature of 250° C.

FIG. 13 shows X-ray diffraction spectra of Al-doped LLZ before and after ion exchange reaction. The lower spectrum is a spectrum of the Al-doped LLZ before introduction of protons, and the upper spectrum is a spectrum of the Al-doped LLZ after introduction of protons.

FIG. 14 shows SEM (scanning electron microscope) images of a fracture near the surface of a thickness portion of Al-doped LLZ before and after an ion exchange reaction. The left image shows an Al-doped LLZ before introduction of protons, and the right image shows an image of a fracture near the surface of a thickness portion after introduction of protons into the Al-doped LLZ.

FIG. 15 shows microscopic Raman spectra of Al-doped LLZ before and after an ion exchange reaction. The lowermost spectrum is a spectrum of the Al-doped LLZ before introduction of protons, and the other spectra are spectra of the Al-doped LLZ after introduction of protons. The spectra after introduction of protons into the Al-doped LLZ includes spectra at relative positions of 0 μm (the surface), 2.3 μm, 25.3 μm, 48.3 μm, 71.3 μm, 85.1 μm, and 87.4 μm (the surface on the other side) from the surface in the thickness direction of the thin film of the sample, in an order from the upper side.

FIG. 16 shows the result of analysis in the depth direction by microscopic Raman spectroscopy after an ion exchange reaction of Al-doped LLZ. Error bars represent standard deviations and ● represent median values.

FIG. 17 is a plot showing measurement results of electrical conductivity of Al-doped LLZ before and after an ion exchange reaction. The relationship between the temperature indicated on the horizontal axis and the common logarithm of electrical conductivity indicated on the vertical axis was plotted. Δ indicates a plot of the Al-doped LLZ before introduction of protons, and ▴ indicates a plot of the Al-doped LLZ after introduction of protons.

### DESCRIPTION OF EMBODIMENTS

In the present invention, a numerical range represented using “(from) . . . to” means a range including numerical values described before and after “to” as a lower limit value and an upper limit value.

### Method for Producing Proton-containing Oxide

In a method for producing a proton-containing oxide of the present invention (hereinafter, also referred to as “the production method of the present invention”), as a result of an ion exchange reaction in which a basic oxide is reacted with a carboxylic acid melt having a pKa of 4 or more, cations of the basic oxide are exchanged with protons of the carboxylic acid having a pKa of 4 or more, and protons are introduced into the basic oxide to generate a proton-containing oxide.

The basic oxide and the carboxylic acid melt having a pKa of 4 or more used in the production method of the present invention, the ion exchange reactions described above and a washing treatment will be described.

### Basic Oxide

In the production method of the present invention, the term “basic oxide” means an oxide that reacts with a carboxylic acid melt, described later, having a pKa of 4 of more to form a carboxylate salt. Thus, the “basic oxide” is an oxide of at least one element of alkali metals, alkaline earth metals, and transition metals in a low oxidation state (+1 or +2). The basic oxide may contain elements other than oxygen, alkali metals, alkaline earth metals, and transition metals having a low acid number (+1 or +2). Among them, the basic oxide is preferably an oxide of at least one element of alkali metals and alkaline earth metals.

The basic oxide may be a simple oxide being an oxide of a single species of metal element, or may be a composite oxide being an oxide of two or more metal elements. Among them, a composite oxide (basic composite oxide) is preferable.

Of the cation and anion constituting the basic oxide, the anion may be an anion containing an oxygen atom. Examples of the anion containing an oxygen atom include oxide ion composed only of an oxygen atom, and a polyanion composed of a polyhedron including a plurality of ions such as [SiO₄]⁴⁻, [PO₄]³⁻, or [GeO₄]³⁻. In the present invention, the oxide ion is not limited to O²⁻, and is used in the sense that it includes an oxide ion with a valence more positive than −2 as a result of formation of a covalent bond. In addition, the oxide ion in the present invention does not mean an oxide ion constituting a polyanion.

In the present invention, an oxide ion is preferably contained as an anion.

In the production method of the present invention, the basic oxide is preferably hydrophilic from the viewpoint of causing ion exchange reaction more smoothly.

In the production method of the present invention, the basic oxide may have a crystal structure or may be amorphous, but preferably has a crystal structure. In the present invention, “has a crystal structure” means that the presence of a region having translational symmetry can be confirmed by using X-ray diffraction.

In addition, in the production method of the present invention, the form of the basic oxide is not particularly limited, and the basic oxide in any form of a powder, a porous body, a dense body, or a laminate of a porous body and a dense body can be used to obtain a desired proton-containing oxide.

The porous body means a bulk body having a large number of pores (voids), and the dense body means a bulk body that is not a porous body. As a physical property, the dense body is generally impermeable to liquids and gases.

In the present invention, a bulk body having a relative density of 70% or more is defined as a dense body.

The relative density means a percentage of an actual density to a theoretical density calculated based on a crystal structure, a lattice constant, and a composition. The actual density is a value obtained by dividing the mass measured by an electronic balance with a built-in weight by the average volume measured by a standard digital caliper (calculated from the average of three measurements of each of the diameter and the height).

The relative density of the dense body in the present invention is preferably 75% or more, more preferably 80% or more, and still more preferably 85% or more. The upper limit is not particularly limited, and is practically 100% or less.

In the present invention, in order to maintain the skeleton of the crystal structure after the introduction of protons into the basic oxide, the basic composite oxide preferably contains at least one element species having a high basicity and at least one element species having a lower basicity.

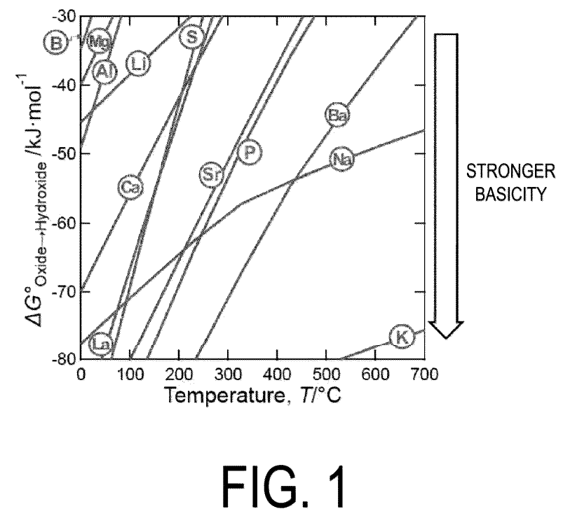

The element species having high basicity can be selected based on a free energy change ΔG°_{Oxide→Hydroxide} when a hydroxide is generated from a simple oxide. As shown in FIG. 1, B, Mg, Al, Li, Ca, S, La, Sr, P, Ba, Na, and K, which have a ΔG°_{Oxide→Hydroxide} of −30 KJ/mol or less at room temperature (25° C.), are considered as element species having high basicity.

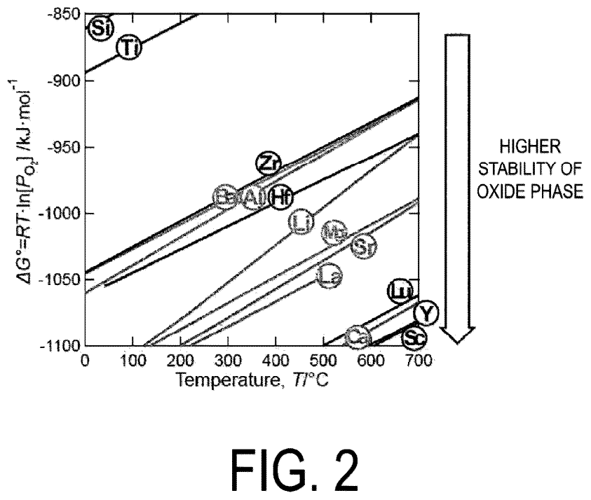

The element species having low basicity means elements having high ΔG°_{Oxide→Hydroxide}, but there is no known thermodynamic data of such elements and thus the ΔG°_{Oxide→Hydroxide} of such elements is not shown. Therefore, the element species having low basicity can be selected based on the chemical stability of the oxide phase by using change in free energy of formation ΔG°_{Oxide} of a simple oxide. As shown in FIG. 2, Si, Ti, Zr, Hf, Lu, Y, and Sc are selected as the element species having low basicity, because these elements have a ΔG°_{Oxide} of −850 KJ/mol or less at room temperature (25° C.) and are not included in the above-described element species having high basicity.

Therefore, the basic oxide is preferably a basic composite oxide containing at least one element species selected from B, Mg, Al, Li, Ca, S, La, Sr, P, Ba, Na, and K, and at least one element species selected from Si, Ti, Zr, Hf, Lu, Y and Sc.

Among the elements constituting the above-described basic composite oxide other than the oxygen element, the ratio of B, Mg, Al, Li, Ca, S, La, Sr, P, Ba, Na, and K is preferably in a range from 20 to 95 at %, more preferably in a range from 30 to 90 at %, and even more preferably in a range from 30 to 85 at %, and the ratio of Si, Ti, Zr, Hf, Lu, Y, and Sc is preferably in a range from 5 to 80 at %, more preferably in a range from 10 to 70 at %, and even more preferably in a range from 15 to 70 at %.

The above-described basic composite oxide may contain elements other than B, Mg, Al, Li, Ca, S, La, Sr, P, Ba, Na, and K as well as Si, Ti, Zr, Hf, Lu, Y, and Sc (hereinafter, referred to as “other elements”), and examples of such elements include Ta and Ga.

Among the elements constituting the above-described basic composite oxide other than the oxygen element, the ratio of the above-described other elements is preferably in a range from 0 to 33 at %, and more preferably in a range from 0 to 15 at %.

In the description above, “at %” means a ratio based on the number of elements.

According to the production method of the present invention, from the viewpoint of obtaining a proton-containing oxide in which ions have been exchanged (protons have been introduced) deeper inside, the above-described basic composite oxide is preferably composed of O; at least one element species selected from B, Mg, Al, Li, Ca, S, La, Sr, P, Ba, Na and K; and at least one element species selected from Si, Ti, Zr, Hf, Lu, Y and Sc. That is, it is preferable that elements other than O, other than B, Mg, Al, Li, Ca, S, La, Sr, P, Ba, Na, and K, and other than Si, Ti, Zr, Hf, Lu, Y, and Sc are not contained.

In Examples described below, the use of a garnet-type Li₇La₃Zr₂O₁₂ (hereinafter, also abbreviated as “LLZ”) derivative or a caswellsilverite analogous type Na₂ZrO₃ as the basic oxide is described, but the basic oxide used in the present invention is not limited to these, and different types of basic oxides can be used. For example, bronze-based crystals such as K₂Ti₈O₁₇ and melilite-type crystals such as Ca₂Al₂SiO₇ can be used.

As the basic oxide, a commercially available product may be used, or a product synthesized by a conventional method may be used. When the basic oxide is prepared by synthesis, there are no particular limitations on the raw materials, mixing, calcination, sintering methods, and the like, and the basic oxide can be synthesized according to conventional methods. For example, as the raw material, general oxides and carbonates can be used, and mixing by a ball mill or the like, calcination by an electric furnace or the like, and sintering may be performed, for example.

### Carboxylic Acid Melt Having pKa of 4 or More

In the production method of the present invention, the carboxylic acid melt having a pKa of 4 or more (hereinafter, also simply referred to as “carboxylic acid melt”) means a melt of a Bronsted acid having an acid dissociation constant (pKa) of 4 or more at room temperature (25° C.) and having one or more carboxy groups.

As long as the above-described carboxylic acid melt is supplied as a melt (liquid carboxylic acid) during heating in the ion exchange reaction, the melting point of the carboxylic acid to be used is not particularly limited. An organic carboxylic acid that can be melted without being thermally decomposed during heating in the ion exchange reaction is preferable.

In addition, in the production method of the present invention, a carboxylic acid melt is used as a proton source, and thus the production method of the present invention is different from methods in the related art in which an aqueous carboxylic acid solution is used as a proton source. That is, in the production method of the present invention, the fact that water is not substantially present in the reaction system of the ion exchange reaction serves as an advantage as described later.

The carboxylic acid melt may be a melt of one type of carboxylic acid or a melt of a mixture of two or more types of carboxylic acids. In the case of a melt of a mixture of two or more types of carboxylic acids, at least one type of carboxylic acid may be melted, and the other carboxylic acid(s) may be melted or may be dissolved in the melted carboxylic acid. In the case of a melt of a mixture of two or more types of carboxylic acids, the pKa of the carboxylic acid melt refers to the pKa of the carboxylic acid exhibiting the lowest pKa. As for a carboxylic acid having two or more pKas, the lowest pKa of the two or more pKas is defined as the pKa of the carboxylic acid melt.

The pKa of the carboxylic acid melt used in the production method of the present invention is 4 or more (4.0 or more), preferably more than 4.2, more preferably 4.3 or more, and still more preferably 4.4 or more. The upper limit of the pKa of the carboxylic acid melt is not particularly limited, but is typically 5.5 or less, preferably 5.0 or less.

In the present invention, pKa means the negative common logarithm (−log Ka) of the acid dissociation constant (Ka) in water at room temperature (25° C.). The pKa can be calculated by adding dropwise a 0.01 mol/L aqueous solution of sodium hydroxide to an aqueous solution of a measurement sample (carboxylic acid) and reading the amount of the aqueous solution of sodium hydroxide that has been added dropwise until reaching the half equivalent point. For an acid insoluble in water, the pKa is calculated by multiplying the acid dissociation constant determined by the above-described titration using another soluble solvent (such as dimethyl sulfoxide) by a conversion constant calculated using the pKa of an acid soluble in both the solvent and water.

The above-described carboxylic acid melt is preferably a fatty acid melt.

In the present invention, the fatty acid melt means a melt of carboxylic acid having a solubility in water (grams dissolved in 100 g of water at 25° C.) of less than 10 g/100 g.

Examples of the fatty acid melt include unsaturated fatty acids having 12 to 22 carbon atoms such as oleic acid, saturated fatty acids having 12 to 22 carbon atoms such as stearic acid and behenic acid, and compounds in which two carboxy groups are bonded to a hydrocarbon having 4 to 8 carbon atoms (which may be saturated or unsaturated) such as adipic acid (solubility in water: 2.4 g/100 g).

The blending ratio of the carboxylic acid melt with respect to the basic oxide is not particularly limited as long as the ion exchange reaction described below proceeds, and it is preferable to use a carboxylic acid melt containing 20 equivalents or more of protons (H in the carboxy group), and it is more preferable to use a carboxylic acid melt containing 100 equivalents or more of protons (H in the carboxy group), with respect to the content of the element substitutable with protons in the basic oxide. The upper limit is not particularly limited as long as the quantity of the carboxylic acid melt is such that the reaction can be performed by immersing the basic oxide in the carboxylic acid melt.

### Ion Exchange Reaction between Basic Oxide and Carboxylic Acid Melt

According to the production method of the present invention, a proton-containing oxide is obtained in which at least a part of cations of at least one of alkali metals, alkaline earth metals, and transition metals in a low oxidation state (+1 or +2) in the basic oxide has been exchanged with protons in the carboxylic acid melt.

Hereinafter, as for the ion exchange reaction in which a basic oxide and a carboxylic acid melt are reacted with each other, an ion exchange reaction using a garnet-type Li₇La₃Zr₂O₁₂ (LLZ) as the basic oxide, and a melt of a carboxylic acid compound having one carboxyl group, R—COOH (R represents a hydrocarbon group. Used below with the same meaning.) as the carboxylic acid melt will be described as an example. However, the ion exchange reaction in the production method of the present invention is not limited to the reaction using these compounds.

The ion exchange reaction between Li₇La₃Zr₂O₁₂ (LLZ) and R-COOH is represented by the following chemical reaction formula. x is a number that satisfies 0<x≤7.

Li₇La₃Zr₂O₁₂+xR-COOH→HₓLi₇₋ₓLa₃Zr₂O₁₂+xR-COOLi

In the chemical reaction formula, at least a part of lithium ions in Li₇La₃Zr₂O₁₂ is exchanged with protons in R-COOH to obtain a proton-containing oxide represented by HₓLi₇₋ₓLa₃Zr₂O₁₂.

The production method of the present invention has the following excellent advantages (1) and (2) based on the use of the ion exchange reaction.

(1) The ion exchange reaction is a reaction in which the carboxylic acid melt itself is used as a proton source and a solvent, and therefore, it is not necessary to use a low boiling point solvent such as water or alcohol. Therefore, as compared with the related art in which ion exchange is performed using a low-boiling-point solvent such as water or alcohol, a high-temperature reaction at, for example, 100° C. or higher can be performed, making it possible to increase the ion exchange reaction rate. Therefore, the form of the basic oxide is not limited to a powder form, and a proton-containing oxide can be obtained even when the basic oxide is a porous body or a dense body. In particular, even when a dense body is used, it is possible to introduce (inject) protons into a deep portion of the dense body.

(2) Further, it is not necessary to use water, and therefore, hydrated proton species having low mobility (H₃O⁺ and H₉O₄⁺) are not generated in principle, and it is considered that the rate of ion exchange reaction is not limited by these hydrated proton species.

In addition, when the basic oxide is hydrophilic and the carboxylic acid melt is hydrophilic, the ion exchange reaction is less likely to be inhibited. Specifically, since the organic carboxylic acid metal salt (R-COOLi) as the by-product is hydrophobic, the organic carboxylic acid metal salt hardly adheres to the surface of the desired proton-containing oxide (HₓLi₇₋ₓLa₃Zr₂O₁₂), which is hydrophilic, and the by-product can be easily removed from the surface of the desired proton-containing oxide by stirring or the like.

In the production method of the present invention, the reaction between the basic oxide and the carboxylic acid melt may be carried out in any manner as long as the basic oxide and the carboxylic acid melt are reacted to cause an ion exchange reaction to obtain a proton-containing oxide in which protons have been introduced into the basic oxide.

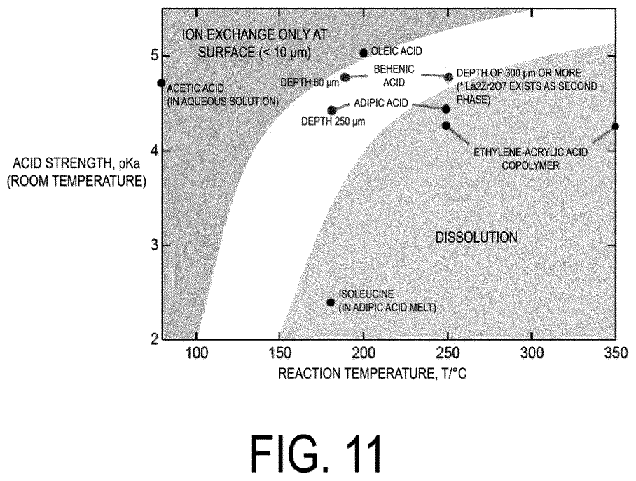

Specifically, by placing the basic oxide and the carboxylic acid melt to be in contact with each other, the ion exchange reaction occurs on the surface of the basic oxide (contact surface with the carboxylic acid melt), and the protons introduced in the surface of the basic oxide as a result of the ion exchange reaction are diffused into the basic oxide by heat, by which it is possible to obtain a proton-containing oxide in which the protons have been introduced to the inside of the basic oxide. This will be described in detail in the results of FIG. 11 and the like described later.

From the viewpoint of injecting protons into the basic oxide at a high concentration, it is preferable that the organic carboxylic acid metal salt as a by-product produced by ion exchange in the surface of the basic oxide is removed from the surface of the proton-containing oxide so that the surface of the proton-containing oxide can be kept in contact with the carboxylic acid melt.

The reaction temperature of the above-described ion exchange reaction may be at least a temperature at which the carboxylic acid melt can be maintained in a molten state, and can be appropriately adjusted depending on the acid strength (pKa) of the carboxylic acid melt or the like. However, from the viewpoint of the rate of the ion exchange reaction, the reaction temperature is preferably in a range from 150 to 350° C., more preferably in a range from 180 to 300° C., even more preferably in a range from 190 to 300° C., and particularly preferably in a range from 200 to 300° C.

The reaction time of the ion exchange reaction can be appropriately adjusted depending on the acid strength (pKa) of the carboxylic acid melt and the like, but is preferably in a range from 1 to 12 hours, more preferably in a range from 2 to 10 hours, even more preferably in a range from 2 to 8 hours, and particularly preferably in a range from 6 to 8 hours from the viewpoint of the balance between the rate of the ion exchange reaction and the productivity.

The reaction time of the ion exchange reaction can be appropriately adjusted depending on the acid strength (pKa) of the carboxylic acid melt and the like. However, from the viewpoint of further increasing the ion exchange rate in addition to the balance between the rate of the ion exchange reaction and the productivity, the reaction time is preferably in a range from 1 to 20 hours, and more preferably in a range from 2 to 18 hours.

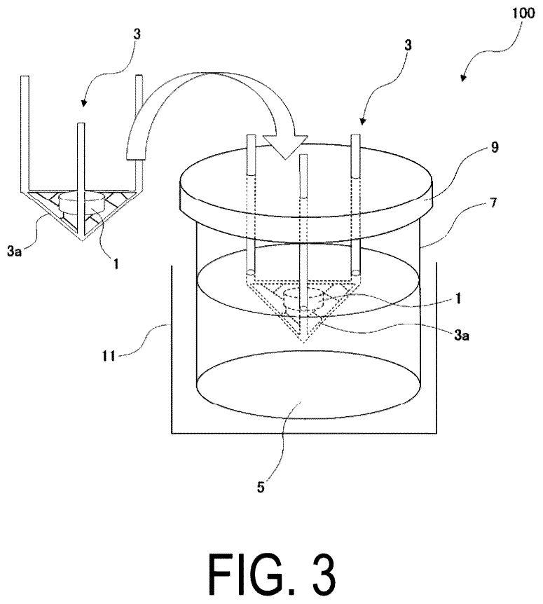

Hereinafter, an example of an apparatus for performing an ion exchange reaction between a basic oxide and a carboxylic acid melt will be schematically described with reference to FIG. 3, but the present invention is not limited to the example, and the size, shape, number, and the like can be appropriately adjusted and changed.

In an ion exchange apparatus 100 illustrated in FIG. 3, a basic oxide 1 is placed on a mesh 3a of a holder 3 having the mesh 3a, and is then immersed in a carboxylic acid melt 5 contained in a reaction vessel 7. The reaction vessel 7 is closed by a lid 9 to which the holder 3 can be fixed and is placed on a mantle heater 11. In the ion exchange apparatus 100 illustrated in FIG. 3, the basic oxide 1 and portions of the holder 3 that are visible through the lid 9 and are immersed in the carboxylic acid melt 5 are represented by broken lines.

The holder 3 is preferably formed of a chemically inert noble metal, and is preferably made of silver from the viewpoint of relatively low cost.

If the basic oxide 1 is a porous body or a dense body, the basic oxide 1 can be placed on the mesh 3a as it is. However, if the basic oxide 1 is in a powder form, the basic oxide 1 can be formed into a green compact through the application of a pressure ranging from around 0.1 to 50 MPa, and then can be placed on the mesh 3a and used in the production method of the present invention. The green compact is formed as a porous body or a dense body depending on the hardness of the particles constituting the powder. In general, when the particles are hard, the green compact is formed as a porous body, and when the particles are soft, the green compact is formed as a dense body. The particles of LLZ used in Examples described later are hard, and therefore, the resulting green compact is a porous body.

The reaction vessel 7 and the lid 9 may be chemically inert, and may be made of, for example, quartz. Provision of the lid 9 makes it possible to suppress volatilization of the carboxylic acid melt 5.

The gas inside the reaction vessel 7 is preferably replaced with an inert gas such as nitrogen in order to prevent oxidation of the carboxylic acid melt 5.

To perform the ion exchange reaction by heating, as illustrated in FIG. 3, the reaction vessel 7 is placed on the temperature-controllable mantle heater 11 for heating the carboxylic acid melt 5. For precise temperature control, a thermocouple (not illustrated in FIG. 3) for measuring the temperature is preferably installed in the vicinity of the basic oxide 1 in the carboxylic acid melt 5.

To improve the efficiency of the ion exchange reaction, the ion exchange apparatus 100 preferably has a stirring function to constantly stir the carboxylic acid melt 5. For example, the reaction vessel 7 is preferably installed in a mantle heater with a stirrer to perform heating and stirring (not illustrated in FIG. 3).

When the basic oxide 1 is placed in an upper part of the carboxylic acid melt 5, the organic carboxylic acid metal salt can be easily separated from the proton-containing oxide obtained by introducing protons into the basic oxide 1, because the specific gravity of the organic carboxylic acid metal salt as a by-product is larger than that of the carboxylic acid melt 5.

### Washing

The melt after the ion exchange reaction (proton introduction treatment) contains a metal salt of an organic carboxylic acid having a high melting point and the metal salt also adheres to the surface of the proton-containing oxide, because of which the proton-containing oxide needs to be washed well. This washing may be insufficient even with acetone that is known to have a strong degreasing power.

In the production method of the present invention, washing can be carried out by using an oil or fat. Specifically, washing can be performed by replacing the melt after the ion exchange reaction (proton introduction treatment) with the oil or fat, and heating again at about 150° C. for a certain period of time while stirring.

The oil or fat may be those containing a fatty acid having a high degree of unsaturation and low viscosity (generally referred to as saturated fatty acids), such as linoleic acid and linolenic acid, and for example, vesitable oil can be used as the oil or fat. Linoleic acid, linolenic acid, and the like are composed of unsaturated hydrophobic carboxylic acids that have polarities similar to those of the organic carboxylic acid metal salts and thus that are compatible with the organic carboxylic acid metal salts. Therefore, linoleic acid, linolenic acid, and the like have an effect of enhancing fluidity, and can be used as an inexpensive detergent.

Note that linoleic acid and linolenic acid have a low acidity (exhibit pKa of 4.8 and 5.0, respectively, at room temperature (25° C.)) and the proton-containing oxide is not dissolved during this washing treatment.

During heat-stirring washing in the oil or fat, the heating temperature and the stirring time are not particularly limited as long as washing effect is achieved, and can be appropriately adjusted.

After this washing treatment, the proton-containing oxide is rinsed with acetone. As a result, a clean oxide after the proton introduction treatment (proton-containing oxide) can be obtained.

### Proton-Containing Oxide

The “proton-containing oxide” obtained by the production method of the present invention means a proton-containing oxide in which at least a part of cations of at least one of alkali metals, alkaline earth metals, and transition metals in a low oxidation state (+1 or +2) in a basic oxide has been exchanged with protons as a result of the above-described ion exchange reaction.

For example, a proton-containing oxide represented by HₓLi₇₋ₓLa₃Zr₂O₁₂ (where x is a number that satisfies 0<x≤7) is obtained when Li₇La₃Zr₂O₁₂ (LLZ) is used as the basic oxide, and a proton-containing oxide represented by H_{y}Na_{2-y}ZrO₃ (where y is a number that satisfies 0<y<1.5) is obtained when Na₂ZrO₃ is used as the basic oxide.

The production method of the present invention “can be applied to a raw material in any form of a powder, a porous body, and a dense body” means that a proton-containing oxide in which protons have penetrate to at least a depth of 10 μm or more from the surface can be obtained even when a basic oxide in a dense body form in which proton introduction to the inside is significantly difficult is used as a raw material.

### Dense Body of Proton-containing Basic Composite Oxide

According to the production method of the present invention, a dense body of a proton-containing basic composite oxide containing at least one element species selected from B, Mg, Al, Li, Ca, S, La, Sr, P, Ba, Na and K, and at least one element species selected from Si, Ti, Zr, Hf, Lu, Y and Sc, and also containing an oxide ion (hereinafter, also referred to as “a dense body of the proton-containing basic composite oxide of the present invention”) can be obtained as a novel proton-containing oxide.

The term “dense body of a proton-containing basic composite oxide” means a dense body of a proton-containing oxide obtained by replacing, with protons, at least a part of cations of at least one of alkali metals and alkaline earth metals in basic composite oxide containing at least one element species selected from B, Mg, Al, Li, Ca, S, La, Sr, P, Ba, Na and K, and at least one element species selected from Si, Ti, Zr, Hf, Lu, Y and Sc, and also containing an oxide ion. Therefore, the dense body of a phosphate-based glass proton-introduced body, the dense body of a proton-introduced body of Li_{13.9}Sr_{0.1}Zn(GeO₄)₄, and the like which do not contain oxide ions are not included in the dense body of the proton-containing basic composite oxide of the present invention.

The dense body of the proton-containing basic composite oxide of the present invention has low gas permeability because of being a dense body. In addition, the dense body of the proton-containing basic composite oxide of the present invention is a basic composite oxide containing an element having high basicity (at least one element species selected from B, Mg, Al, Li, Ca, S, La, Sr, P, Ba, Na and K), and an element having low basicity (at least one element species selected from Si, Ti, Zr, Hf, Lu, Y and Sc), and also containing an oxide ion, and thus a crystal structure of the dense body is not likely to change even after the introduction of protons and is stable. Therefore, as compared to the dense body of a phosphate-based glass proton-containing body and the dense body of a proton-introduced body of Li_{13.9}Sr_{0.1}Zn(GeO₄)₄, the dense body of the proton-containing basic composite oxide of the present invention is a rigid body that is not deformed even at a high temperature of 200° C. or more.

### Solid Electrolyte, Fuel Cell, Hydrogen Production Cell, Hydrogen Sensor, or Ammonia Synthesis Cell

The proton-containing oxide obtained by the production method of the present invention is expected to exhibit stable proton conductivity in an intermediate temperature range from 300 to 600° C.

Therefore, the proton-containing oxide obtained by the production method of the present invention is expected to be used as a solid electrolyte material, and the solid electrolyte obtained from the proton-containing oxide obtained by the production method of the present invention is expected to be used in a fuel cell, a hydrogen production cell, a hydrogen sensor, or an ammonia synthesis cell.

### EXAMPLES

Hereinafter, the present invention will be described more specifically through examples, but the present invention is not limited by these examples, except for matters specified in the present invention.

### EXAMPLE 1

### Synthesis of Basic Oxide

The basic oxide was synthesized by a general firing method as described below.

(1) Synthesis of Powder of Na₂ZrO₃

Firstly, as the raw material oxides, ZrO₂ and Na₂CO₃ that had been dried at 300° C. for 5 hours prior to ball-milling because of its hygroscopicity were milled together with hexane by using a planetary ball mill for 10 hours at a rotation speed of 400 rpm. The blending ratio of each raw material oxide was adjusted so that Na was included excessively by 10 mol % with respect to the target composition ratio in consideration of sublimation during firing. Hydrophobic hexane was used to suppress the reaction between water (moisture in the air) and the raw materials.

The obtained mixed powder was pelletized into a shape having a diameter of 10 mm and a thickness of 3 mm using a uniaxial press, then subjected to cold isostatic pressing at 20 MPa, heated at a rate of 5° C./min using a magnesia crucible, and calcined (fired) at 950° C. for 12 hours. In the calcination, a magnesia crucible was used instead of a general alumina crucible to prevent aluminum contamination. To suppress sublimation and unintended reaction, the pellet was covered with a buffer powder having the same composition and then calcined. After the calcination, both surfaces of the pellet were polished, and the pellet was pulverized with a ball mill and pelletized in the same manner as described above, followed by firing in the same manner as the calcination method described above.

As a result of the above process, a dense pellet of Na₂ZrO₃ (a dense body having a relative density of 82% or more) having a diameter of 9 mm and a thickness of 1 mm was produced.

A powder sample was prepared by pulverizing the pellet again using a ball mill in the same manner as described above.

(2) Synthesis of Dense Bodies and Powders of Li_{6.16}Al_{0.28}La₃Zr₂O₁₂ (Al-Doped LLZ) and Li₆La₃Zr₁Ta₁O₁₂ (Ta-Doped LLZ)

The Al-doped LLZ powder and the Ta-doped LLZ powder were prepared in the same manner as in the preparation of the Na₂ZrO₃ powder sample described in (1) above except that Li₂CO₃ and ZrO₂, and Al₂O₃ or Ta₂O₅, as well as La₂O₃ that was fired at 700° C. for 5 hours prior to ball milling because of its hygroscopicity were used as raw material oxides. The blending ratio of each raw material oxide was adjusted so that Li was included excessively by 10 mol % with respect to the target composition ratio in consideration of sublimation during firing.

As the dense bodies of the Al-doped LLZ and the Ta-doped LLZ, dense pellets (dense bodies having relative densities of 82% or more) of the Al-doped LLZ and the Ta-doped LLZ having a diameter of about 9 mm and a thickness of about 1 mm obtained in the process of preparing the powder were used.

(3) Production of Thin Film (Dense Body) of Li_{6.16}Al_{0.28}La₃Zr₂O₁₂ (Al-Doped LLZ)

The pellet of the Al-doped LLZ produced in (2) above was pulverized using a ball mill in the same manner as in (1) above to prepare a pulverized powder of the Al-doped LLZ.

In a mortar, 3 g of the pulverized powder of the Al-doped LLZ prepared as described above, 0.5 g of polyvinyl butyral (average polymerization degree: 630), 250 μL of dibutyl phthalate, 100 μL of ethylene glycol, 100 μL of polyoxyethylene (average polymerization degree: 10) oxyphenyl ether, 2 mL of isopropyl alcohol, and 2 mL of toluene were mixed to prepare an Al-doped LLZ slurry.

The Al-doped LLZ slurry thus prepared was used to prepare a green sheet with a doctor blade having a gap of 500 μm. The green sheet was heated to 500° C. at a heating rate of 2° C./min. Then, the temperature is held at 500° C. for 3 hours, increased to 1200° C. at a heating rate of 10° C./min, held at 1000° C. for 10 hours, and decreased to room temperature at a cooling rate of 10° C./min. As a result, a dense thin film of Al-doped LLZ having a thickness of about 90 μm (a dense body having a relative density of 92±5% or more) was obtained. The relative density of the thin film formed by the doctor blade method is described as a value including a measurement error of ±5% in consideration of a measurement error of a volume measured and calculated by using a standard digital caliper.

### Immersion of Basic Oxide in Carboxylic Acid Melt (Ion Exchange Reaction)

Immersion of the Al-doped LLZ pellet and the Ta-doped LLZ pellet in the carboxylic acid melt was conducted using a quartz vessel in the ion exchange apparatus 100 schematically illustrated in FIG. 3.

The vessel (the reaction vessel 7) was installed in a mantle heater 11 with a stirrer for temperature control and removal of lithium salt of the carboxylic acid as a by-product from the surface of the basic oxide sample. For a more uniform reaction of the LLZ pellet (basic oxide 1), the silver holder 3 having the silver mesh 3a was used. The LLZ pellet (the basic oxide 1) was placed on the mesh 3a and suspended to be positioned at the upper part of the inside of the reaction vessel 7. For accurate temperature control, a thermocouple was installed near the LLZ pellet (basic oxide 1) in the carboxylic acid melt 5. To prevent degradation accompanied by the oxidation of the carboxylic acid melt 5, and to view the condition of the sample during the reaction, the entire ion exchange apparatus 100 system was placed in a transparent chamber filled with nitrogen. A carboxylic acid containing protons (H in a carboxy group) in an amount of 100 times or more the Li content of the LLZ pellets (basic oxide 1) was placed in the reaction vessel 7. The carboxylic acid melt 5 was prepared using a mantle heater, the position of the holder 3 was adjusted so that the LLZ pellet (basic oxide 1) was immersed in the carboxylic acid melt 5 to cause ion exchange reaction. During the reaction, the lid 9 made of quartz having through-holes for the holder 3 was put on to suppress evaporation of the carboxylic acid melt 5.

Immersion of the powders of Al-doped LLZ, Ta-doped LLZ, and Na₂ZrO₃ in the carboxylic acid melt was performed in the same manner as described above except that the powder was slightly uniaxially pressed at about 100 kPa to form a green compact having a diameter of 10 mm and a thickness of 1 mm, and then placed on the mesh 3a.

The type of the carboxylic acid melt used in the ion exchange reaction, the reaction temperature, and the reaction time are as per each evaluation described later.

### Washing

The LLZ pellet after the ion exchange reaction was washed with edible oil heated to about 150° C. to remove the lithium salt of the carboxylic acid potentially remaining on the surface. Specifically, the carboxylic acid melt (including the lithium salt of the carboxylic acid) after the reaction in the reaction vessel 7 was replaced with the edible oil heated to about 150° C., heated and stirred at 150° C. for about 20 minutes, and the LLZ pellet after the ion exchange reaction was taken out from the edible oil. Thereafter, the LLZ pellet was ultrasonically washed with acetone to obtain a clean sample.

The green compact after the ion exchange reaction was washed in the same manner as described above to remove the sodium salt of the carboxylic acid potentially remaining on the surface.

The proton-containing oxide thus obtained was subjected to the evaluations described below.

### [Evaluation 1] Caswellsilverite Analogous Type Na₂ZrO₃ Derivative

(Reaction Conditions) Basic Oxide: Green Compact of Na₂ZrO₃ Powder, Carboxylic Acid Melt: Oleic Acid (Having pKa Slightly Higher than 5), Reaction Temperature: 300° C., Reaction Time: 2 Hours

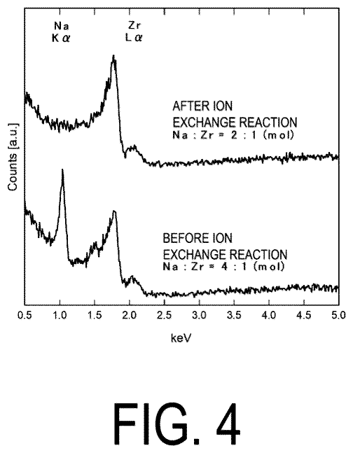

FIG. 4 shows the results of qualitative and quantitative analysis of elements by EDS (energy dispersive X-ray spectroscopy) of Na₂ZrO₃ before and after the ion exchange reaction (proton introduction reaction). In FIG. 4, the horizontal axis represents the energy value (unit: keV) and the vertical axis represents the count. From the ratio between the integral values of the counts for the Kα line of Na (from 0.99 to 1.09 keV) and the Lα line of Zr (from 1.99 to 2.09 keV), it was found that the elemental composition ratio in the raw material Na₂ZrO₃ before the introduction of protons was about Na:Zr=4:1 (see the lower spectrum in FIG. 4), whereas, after the introduction of protons, the elemental composition ratio in the oxide changed to about Na:Zr=2:1 (see the upper spectrum in FIG. 4).

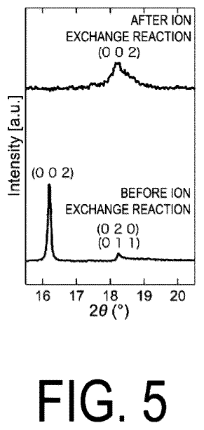

As shown in FIG. 5, as a result of the X-ray diffraction before and after the ion exchange reaction, it was found that the diffraction peak of (002) of the caswellsilverite analogous type Na₂ZrO₃ shifted from 2θ=16.4° (see the lower spectrum in FIGS. 5) to 2θ=18.2° (see the upper spectrum in FIG. 5), which corresponds to 11% shrinkage of the interlayer distance according to the Bragg's reflection equation.

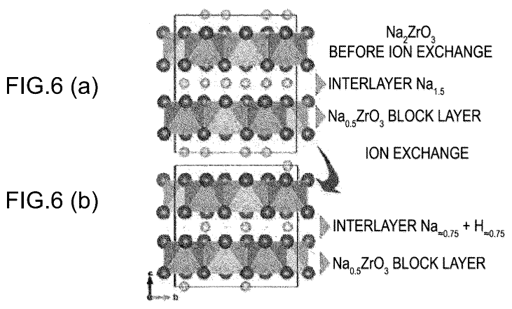

These results indicate that a proton-containing oxide was obtained in which Na_{1.5} previously present between the Na_{0.5}ZrO₃ block layers in the Na₂ZrO₃ crystal structure before the introduction of protons, as illustrated in FIG. 6(a), was replaced (ion-exchanged) with Na_{0.75}+H_{0.75} as illustrated in FIG. 6(b). In FIG. 6, dark circles (●) represent oxygen atoms, and light circles (◯) represent sodium atoms. That is, it was found that protons were sufficiently introduced into the Na₂ZrO₃ green compact and penetrate to the center (500 μm from the surface) of the green compact.

### [Evaluation 2] Garnet-type Li₇La₃Zr₂O₁₂ (LLZ) Derivative-1

### (1) (Reaction Conditions) Basic Oxide: Green Compact of the Al-doped LLZ Powder Prepared in (2) Above, Carboxylic Acid Melt: Oleic Acid, Reaction Temperature: 150° C., Reaction Time: 2 Hours

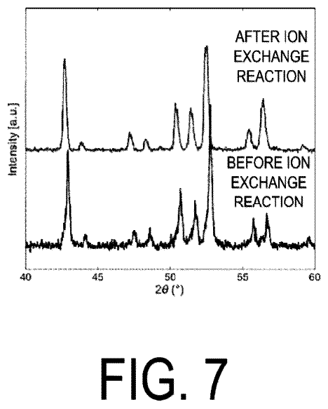

As a result of the X-ray diffraction analysis before and after the ion exchange reaction, as shown in FIG. 7, a shift in the X-ray diffraction peak was observed, and it was confirmed that an oxide having a modified structure that still had the crystal structure of the Al-doped LLZ and into which protons were introduced (ion exchanged) was obtained as in the case of the above-mentioned caswellsilverite analogous type Na₂ZrO₃.

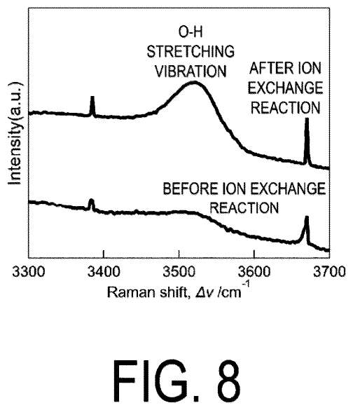

As a result of the Raman spectroscopy, as shown in FIG. 8, an O—H stretching vibration peak that was only unclearly observed for the Al-doped LLZ as the raw material before the introduction of protons (before the ion exchange reaction) was clearly observed near 3520 cm⁻¹ after the introduction of protons (after the ion exchange reaction).

From these results, it was confirmed that an oxide having a modified structure in which a part of Li⁺ in the Al-doped LLZ crystal structure before the proton introduction was replaced with H⁺ was obtained. That is, it was found that protons were sufficiently introduced into the green compact of the Al-doped LLZ powder and penetrate to the center (500 μm from the surface) of the green compact.

(2) (Reaction Conditions) Basic Oxide: Dense Body of Al-Doped LLZ or Ta-Doped LLZ Prepared in (2) Above (Relative Density: 82% or more, Porosity: about 15%), Carboxylic Acid Melt: Adipic Acid (pKa 4.4), Reaction Temperature: 180° C., Reaction Time: 8 Hours

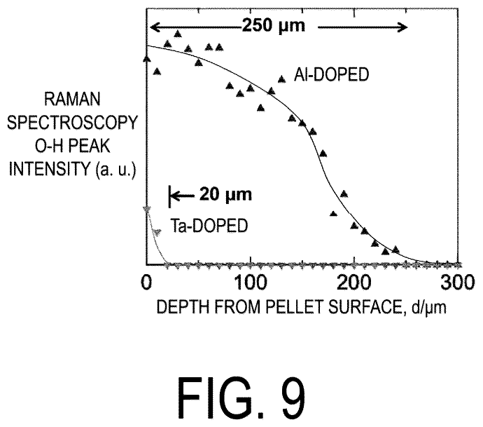

FIG. 9 shows a plot of the relationship between the depth from the pellet surface indicated on the horizontal axis and the O—H stretching vibration peak intensity indicated on the vertical axis obtained by performing analysis in the depth direction for the oxide after the ion exchange reaction of each pellet-shaped sintered body (porosity: about 15%) of the Al-doped LLZ and the Ta-doped LLZ by using Raman spectroscopy. In the Raman spectroscopy of the present invention, analysis was performed every 10 μm in the depth direction from the surface (at a depth of 0 μm), and the deepest depth at which O—H stretching vibration peak was no longer observed was defined as the maximum depth of proton introduction.

As shown in FIG. 9, it was confirmed that protons were introduced in a region from the surface (0 μm) to a depth of 20 μm in the Ta-doped LLZ (indicated by ▾ in FIG. 9), and protons were introduced in a region from the surface (0 μm) to a depth of about 250 μm in the Al-doped LLZ (indicated by ▴ in FIG. 9).

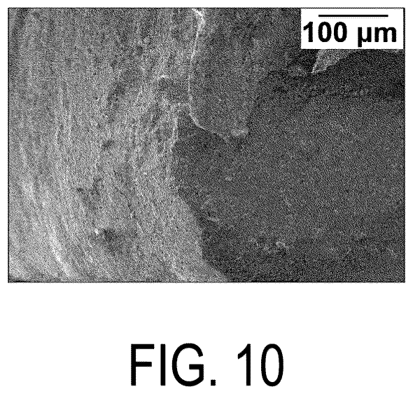

As shown in FIG. 10, in observation using a scanning electron microscope, no crack or the like was found in a fracture near the surface of the pellet-shaped sintered body of Al-doped LLZ after the ion exchange reaction.

From these results, it was confirmed that after the ion exchange on the surface of the Al-doped LLZ, protons were diffused to the inside, and thus, an oxide in which protons were introduced all the way inside was obtained.

### [Evaluation 3] Garnet-Type Li₇La₃Zr₂O₁₂ (LLZ) Derivative-2

(Reaction Conditions) Basic Oxide: Dense Body of Al-Doped LLZ Prepared in (2) Above (Relative Density: 82% or more, Porosity: about 15%), Reaction Time: 8 hours

Ion exchange reactions were carried out by using, as a proton introduction source, an acetic acid aqueous solution or various carboxylic acid melts, and using different reaction temperatures. The obtained oxides were subjected to surface analysis and depth direction analysis by Raman spectroscopy to measure the O-H stretching vibration peak intensity.

In FIG. 11, the relationship between the pKa values (room temperature: 25° C.) of the compounds used as the proton introduction source and the reaction temperatures is plotted, and the maximum depths at which proton introduction was confirmed in each test are also shown. In FIG. 11, “ion exchange only at surface (<10 μm)” means that the O—H stretching vibration peak was observed in the surface analysis but the O—H stretching vibration peak was not observed on the surface (depth 0 μm) in the depth direction analysis, and “dissolved by the acid” means that the basic oxide was dissolved by the acid.

As shown in FIG. 11, when an aqueous acetate solution (pKa 4.7) was used at a reaction temperature of 80° C., ion exchange occurred only in a region from the surface to a depth of less than 10 μm. In addition, because of being an aqueous solution, the reaction temperature could not be raised to 100° C. or higher, making it difficult to introduce protons further into the interior.

In the case of isoleucine in adipic acid melt (pKa 2.3) used at a reaction temperature of 180° C., the case of an ethylene-acrylic acid copolymer melt (including 15 wt. % of acrylic acid component, pKa 4.2) used at a reaction temperature of 250° C. or 350° C., and the case of adipic acid melt (pKa 4.4) used at a reaction temperature of 250° C., the basic oxide was dissolved by the acid and the desired proton-containing oxide was not obtained.

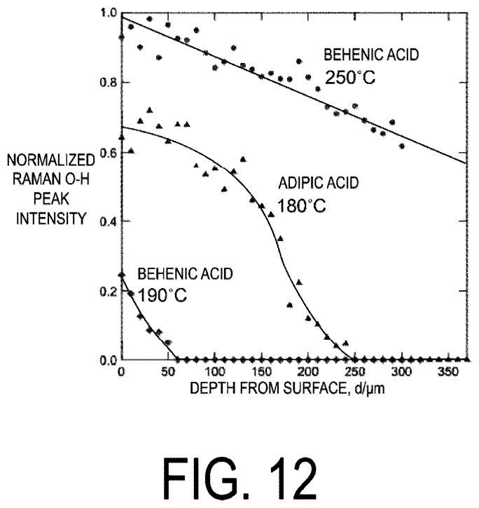

On the other hand, when adipic acid (pKa 4.4) or behenic acid (pKa 4.7) being a carboxylic acid melt having a pKa of 4 or more was used, ion exchange could be achieved up to 60 μm or more in the depth direction by setting the reaction temperature to such an extent that the basic oxide was not dissolved by the acid. In particular, as shown in FIGS. 11 and 12, when adipic acid was used, protons could penetrate to a depth of 250 μm at a reaction temperature of 180° C., and when behenic acid is used, protons could penetrate to a depth of 60 μm at a reaction temperature of 190° C., and to a depth of 300 μm or more at a reaction temperature of 250° C. In the reaction using behenic acid at a reaction temperature of 250° C., the presence of La₂Zr₂O₇ as a second phase was confirmed. In consideration of these results, when the oleic acid melt (pKa 5.0) was used at a reaction temperature of 200° C., the ion exchange occurred only in a region from the surface to a depth of less than 10 μm, but as is apparent from the plot in FIG. 11, the ion exchange can be caused at a deeper portion by increasing the reaction temperature.

Thus, it was found that protons can be introduced in a region from the surface to deep inside by using a carboxylic acid melt having a weak acidity of pKa 4 or more at a high temperature.

### [Evaluation 4] Garnet-Type Li₇La₃Zr₂O₁₂ (LLZ) Derivative-3

(Reaction Conditions) Basic Oxide: Thin Film of Al-Doped LLZ Prepared in (3) Above (Dense Body Having a Relative Density of 92±5% or more), Carboxylic Acid Melt: Behenic Acid (pKa 4.7), Reaction Temperature: 250° C., Reaction Time: 15 Hours

ICP-MS analysis (inductively coupled plasma mass spectrometry), X-ray diffraction, SEM (scanning electron microscope) observation, microscopic Raman spectroscopy, and alternating current impedance spectroscopy were performed on the samples of the Al-doped LLZ thin film before and after the ion exchange reaction.

### ICP-MS Analysis

Each of the samples before and after the ion exchange reactions (introduction of protons) was ground in a mortar, and 1 mL of aqua regia was added to 1 mg of the ground powder and hydrolyzed at 105° C. for 2 hours to form a solution, which was then introduced into an ICP-MS apparatus for analysis.

It was confirmed by ICP-MS analysis that the Li concentration in the samples after the ion exchange reaction was 1/10 of the Li concentration in the samples before the ion exchange reaction, that is, the ion exchange rate in the ion exchange reaction was 90%.

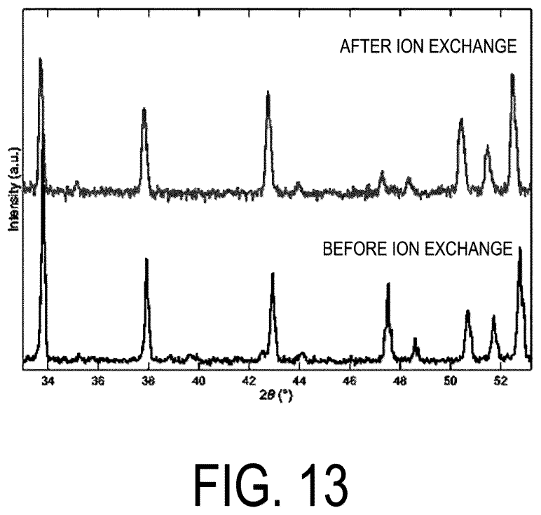

As shown in FIG. 13, a shift of the X-ray diffraction peak was observed in the X-ray diffraction analysis, and it was confirmed that, as a result of the ion exchange reaction, an oxide having a modified structure that still had the crystal structure of the sample before the ion exchange reaction and into which protons were introduced (ion exchanged) was obtained.

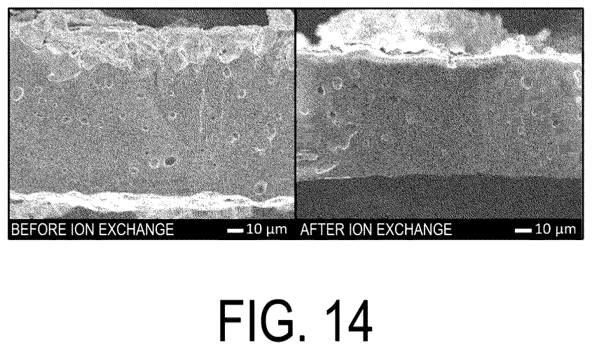

As shown in FIG. 14, it was confirmed by SEM observation that both the samples before and after the ion exchange reaction were dense bodies without cracks, open pores, and the like. In FIG. 14, the difference in the thickness of the sample between the SEM images before and after the ion exchange reaction is caused by unevenness in the thickness of the sample itself.

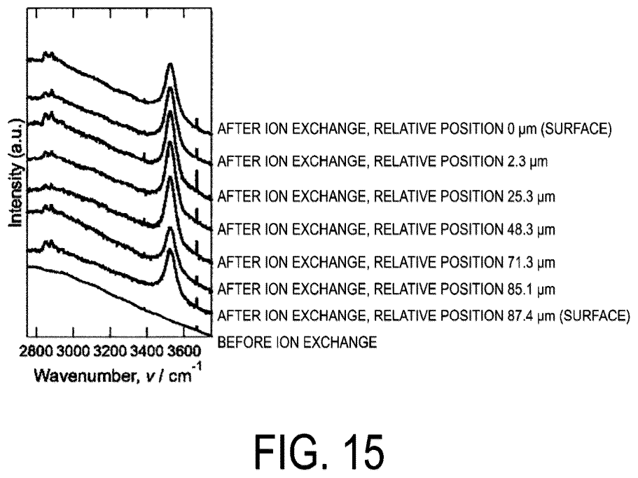

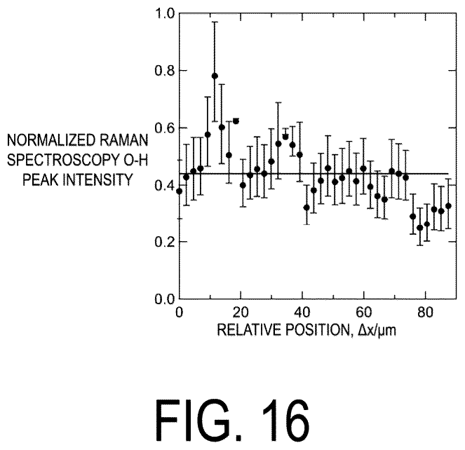

As shown in FIG. 15, in the results of microscopic Raman spectroscopy, the sample after the introduction of protons (after the ion exchange reaction) showed the O—H stretching vibration peak at about 3520 cm⁻¹, from the surface of the sample to the inside (at relative positions of 0 um to 87.4 μm), which was hardly observed for the sample before the introduction of protons (before the ion exchange reaction), and further showed peaks at about 2840 to 2940 cm⁻¹ which are considered to be derived from the O—H stretching vibration. FIG. 16 shows a plot of the relationship between the depth from the sample pellet surface after the ion exchange reaction indicated on the horizontal axis and the O—H stretching vibration peak intensity at about 3520 cm⁻¹ indicated on the vertical axis. As shown in FIG. 16, in the region of the sample from one of the surfaces (relative position 0 μm) to the other of the surfaces (relative position 87.4 μm), it was confirmed that the intensities of the O—H stretching vibration peak at about 3520 cm⁻¹ at the surfaces and internal positions were substantially the same.

From these results, it was confirmed that after the ion exchange on the surface of the thin film of the Al-doped LLZ, protons were diffused to the inside, and thus, an oxide in which protons were uniformly introduced all the way inside was obtained at an ion exchange rate of 90%.

### Alternating Current Impedance Spectroscopy

A platinum paste was applied to the thin film of the Al-doped LLZ for current collection, and connected with platinum electrodes and the impedance spectrum was measured at an AC voltage of 100 mV and an AC frequency in the range of 2×10⁷ to 0.1 Hz while increasing the temperature from 150° C. to 400° C. and while circulating synthetic air in a tubular furnace. The point at which the impedance spectrum intersects the real axis in the Nyquist plot was taken as the real resistance value, which was converted to electrical conductivity using the current collection area and sample thickness.

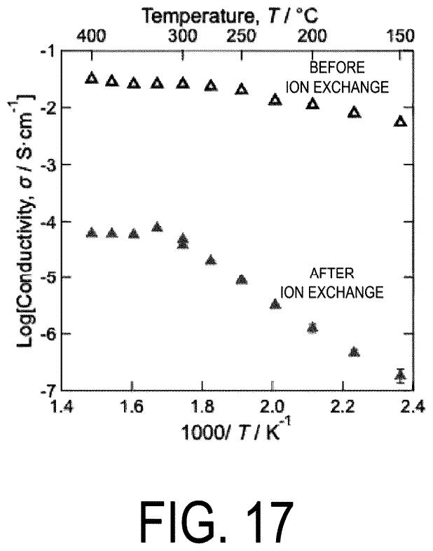

FIG. 17 shows a plot of the relationship between the measurement temperature indicated on the horizontal axis and the common logarithm of the calculated electrical conductivity indicated on the vertical axis. In the Al-doped LLZ before ion exchange, lithium ion conductivity mainly contributes to the electrical conductivity. In the Al-doped LLZ after ion exchange, proton conductivity mainly contributes to the electrical conductivity. As shown in FIG. 17, according to the alternating current impedance spectroscopy, the sample after the ion exchange reaction has a proton conductivity of about 1×10⁻⁴ S·cm⁻¹ in the temperature range of 325° C., and it was confirmed that a proton-containing oxide exhibiting high proton conductivity was easily obtained by the present invention.

Although the present invention has been described with reference to embodiments thereof, we do not intend to limit our invention to any detail of the description unless otherwise specified. It should be broadly construed without departing from the spirit and scope of the invention as set forth in the appended claims.

### REFERENCE SIGNS LIST

1: Basic oxide
3: Holder
3a: Mesh
5: Carboxylic acid melt
7: Reaction vessel
9: Lid
11: Mantle heater
100: Ion exchange apparatus

1. A method for producing a proton-containing oxide, the method comprising reacting a basic oxide with a carboxylic acid melt having a pKa of 4 or more to introduce protons into the basic oxide to obtain a proton-containing oxide.

2. The method for producing the proton-containing oxide according to claim 1, wherein
the basic oxide is a basic composite oxide containing at least one element species selected from B, Mg, Al, Li, Ca, S, La, Sr, P, Ba, Na, and K, and at least one element species selected from Si, Ti, Zr, Hf, Lu, Y, and Sc.

3. The method for producing the proton-containing oxide according to claim 1, wherein
the basic oxide is of a garnet type or a caswellsilverite analogous type.

4. The method for producing the proton-containing oxide according to claim 1, wherein
the carboxylic acid melt is a fatty acid melt.

5. The method for producing the proton-containing oxide according to claim 1, wherein
a reaction temperature of the reaction is in a range from 150 to 350° C.

6. The method for producing the proton-containing oxide according to claim 1, wherein
a reaction time of the reaction is in a range from 1 to 20 hours.

7. The method for producing the proton-containing oxide according to claim 1, the method further comprising washing after the reaction.

8. The method for producing the proton-containing oxide according to claim 1, wherein
the washing is performed using an oil or fat.

9. A method for producing a fuel cell, a hydrogen production cell, a hydrogen sensor, or an ammonia synthesis cell, the method comprising
incorporating, as a solid electrolyte, the proton-containing oxide obtained by the method for producing the proton-containing oxide according to claim 1.

10. A dense body of a proton-containing basic composite oxide, containing at least one element species selected from B, Mg, Al, Li, Ca, S, La, Sr, P, Ba, Na and K, and at least one element species selected from Si, Ti, Zr, Hf, Lu, Y and Sc, and further containing an oxide ion.

11. A solid electrolyte, comprising the dense body of the proton-containing basic composite oxide according to claim 10.

12. A fuel cell, a hydrogen production cell, a hydrogen sensor, or an ammonia synthesis cell, comprising the solid electrolyte according to claim 11.
